(19) United States
(12) Patent Application Publication
(10) Pub. No.: US 2026/0016873 A1
(43) Pub. Date: Jan. 15, 2026

(54) Techniques For Thermal And Power Management In Integrated Circuits

(71) Applicant: Altera Corporation, San Jose, CA (US)

(72) Inventors: Dannie Feekes, Corvallis, OR (US); Krishnakumar Varadarajan, Bangalore (IN)

(73) Assignee: Altera Corporation, San Jose, CA (US)

(21) Appl. No.: 19/336,448

(22) Filed: Sep. 22, 2025

(51) Int. Cl. G06F 1/20; G06F 1/324; G06F 11/30; G06F 30/392; G06F 119/08

(52) U.S. Cl. CPC G06F 1/206; G06F 1/324; G06F 11/3058; G06F 30/392; G06F 2119/08

(57) ABSTRACT

An integrated circuit includes temperature sensors that generate temperature sensor data indicating temperatures in the integrated circuit, a thermal management controller circuit that identifies at least one hot spot in at least one location that is different from locations of the temperature sensors using the temperature sensor data and thermal coefficient data, and a power management controller circuit that decreases power of at least one circuit block corresponding to the at least one hot spot in a circuit design for the integrated circuit to reduce a temperature of the at least one hot spot.

### BACKGROUND

Configurable integrated circuits can be configured by users to implement desired custom logic functions. In a typical scenario, a logic designer uses computer-aided design (CAD) tools to design a custom circuit design. When the design process is complete, the computer-aided design tools generate configuration data containing configuration bits in a configuration bitstream. The configuration data is then loaded into configuration memory elements that configure configurable logic circuits in the integrated circuit to perform the functions of the custom circuit design. Configurable integrated circuits can be used for co-processing in big-data or fast-data applications. For example, configurable integrated circuits can be used in application acceleration tasks in a datacenter and can be reprogrammed during datacenter operation to perform different tasks.

### BRIEF DESCRIPTION OF DRAWINGS

FIG. 1 is a diagram that illustrates an example of a temperature and power control system for a configurable integrated circuit.

FIG. 2 is a diagram that illustrates an example of a temperature map showing hot spots in a configurable integrated circuit (IC) that occur as a result of a workload of a circuit design for the IC generating heat.

FIG. 3 is a flow chart that illustrates examples of operations that can be performed to reduce the temperature of one or more hot spots in a circuit design for a configurable integrated circuit (IC).

FIG. 4 is a diagram of an illustrative example of a configurable integrated circuit (IC).

FIG. 5 illustrates a block diagram of a system that can be used to implement a circuit design to be programmed into a programmable logic device using design software.

FIG. 6 is a diagram that depicts an example of a programmable logic device that includes fabric dies and base dies that are connected to one another via microbumps.

FIG. 7 is a block diagram illustrating a computing system configured to implement one or more aspects of the embodiments described herein.

### DETAILED DESCRIPTION

Heat control systems for configurable integrated circuits (ICs) are often implemented in an external board management controller (BMC) that monitors a junction temperature of the configurable IC at discrete locations in the IC die and then adjusts the speed of a fan accordingly. In other heat control systems, management happens at the IC package level. These systems use a uniform power density across the IC package or across the IC die.

If a heat control system does not have information about the temperature profile of an IC die, or the impact of specific circuits within the IC die on the temperature of the IC die and the temperature ramp rates of the IC die based on power, the heat control system typically causes the entire IC performance to be reduced to manage the IC die temperature. For example, if information is not available that a hot spot in an IC die is in the input/output (IO) region of the IC die, and that throttling only 2 out of the 4 active IO circuits will provide the necessary temperature control, the IC die requires a more widespread throttling of performance to achieve the same temperature impact.

According to some examples disclosed herein, a thermal management controller in a configurable integrated circuit (IC) receives thermal coefficients for the configurable IC as a part of a configuration bitstream for configuring a circuit design into the configurable IC. The thermal coefficients are calculated during synthesis of the circuit design for the configurable IC. The thermal coefficients enable the thermal management controller to dynamically calculate a junction temperature for any location in the IC die from discrete thermal sensors in the IC die. The circuit blocks in the circuit design for the IC die that are associated with thermal hot spots are identified. Identifying the hot spots in the circuit design enables the thermal management controller to intelligently select a power management scheme that provides the optimal thermal mitigation reduction with minimal performance degradation in the IC die. If the IC die is cooled with a fan, the speed of the fan (and also the power of the system) can be reduced in response to the power management scheme.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Throughout the specification, and in the claims, the terms “connected” and “connection” mean a direct electrical connection between the circuits that are connected, without any intermediary devices. The terms “coupled” and “coupling” mean either a direct electrical connection between circuits or an indirect electrical connection through one or more passive or active intermediary devices that allows the transfer of information between circuits. The term “circuit” may mean one or more passive and/or active electrical components that are arranged to cooperate with one another to provide a desired function.

This disclosure discusses integrated circuit devices, including configurable (programmable) integrated circuits, such as field programmable gate arrays (FPGAs) and programmable logic devices. As discussed herein, an integrated circuit (IC) can include hard logic and/or soft logic. The circuits in an integrated circuit device (e.g., in a configurable IC) that are configurable by an end user are referred to as “soft logic.” “Hard logic” generally refers to circuits in an integrated circuit device that have substantially less configurable features than soft logic or no configurable features.

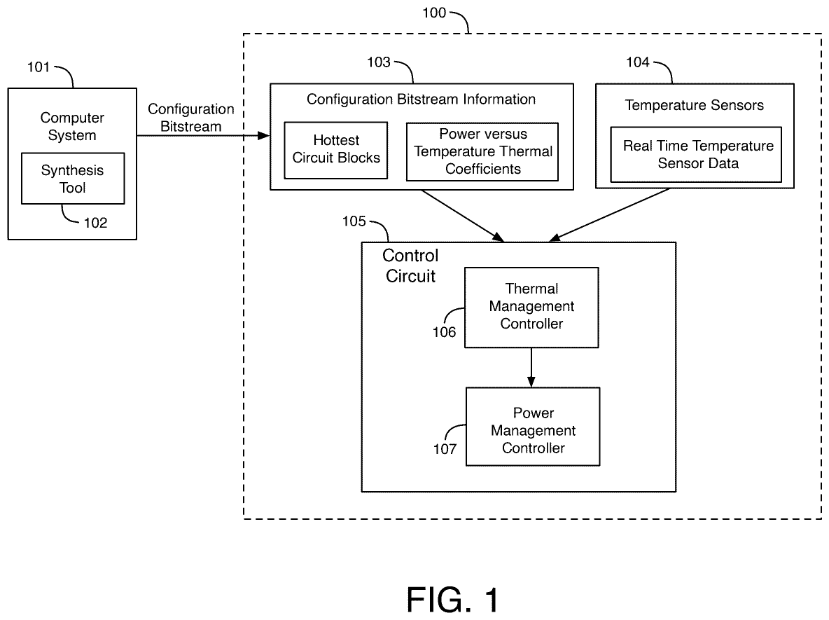

FIG. 1 is a diagram that illustrates an example of a temperature and power control system for a configurable integrated circuit. The temperature and power control system of Figure (FIG. 1 includes a computer system 101 and a configurable integrated circuit (IC) die 100 (also referred to as a configurable IC) that includes temperature sensors 104 and a control circuit 105. The computer system 101 includes a synthesis tool 102. The synthesis tool 102 can synthesize a custom circuit design for the configurable IC 100 to generate a configuration bitstream 103 that can be used to implement the circuit design in the configurable IC. The computer system 101 sends the configuration bitstream 103 to the configurable IC 100. The configurable IC 100 uses the configuration bitstream 103 to configure configurable circuit blocks in the configurable IC 100 to implement the circuit design.

The control circuit 105 in IC 100 includes a thermal management controller 106 and a power management controller 107. The thermal management controller 106 can be implemented by hardware circuitry configured by custom software and/or firmware. The power management controller 107 can also be implemented by hardware circuitry configured by custom software and/or firmware.

The synthesis tool 102 estimates the temperature of the entire configurable IC die 100 for any given power map of a circuit design for the configurable IC die to generate a temperature map for the circuit design using a temperature map generator circuit. The temperature map indicates the maximum temperature of the configurable IC die 100 and the temperatures of the locations in the configurable IC die 100 where the temperature sensors 104 are located. The temperature map can, as examples, be color coded (e.g., with red, orange, yellow, green, and blue) or gray shaded to indicate variations of the temperature across the circuit design in the IC. The temperature map can be generated using influence coefficient matrices (ICM) that identify the influence of power at various locations in the IC die 100 on the temperature across the entire IC die 100 when the IC die 100 is configured according to the circuit design.

In addition, synthesis tool 102 identifies the specific location(s) of one or more hot spots in a circuit design for the configurable IC die 100 and the specific circuit blocks within the circuit design that are generating the one or more hot spots based on the temperature map for any given performance scenario for the circuit design. For example, the synthesis tool 102 can use a temperature map for a circuit design to determine that the hottest temperature in a configurable IC die when configured and operating according to the circuit design is in an input/output (IO) subsystem in the IC die and caused by multiple IO circuit blocks in the IO subsystem running at maximum speeds.

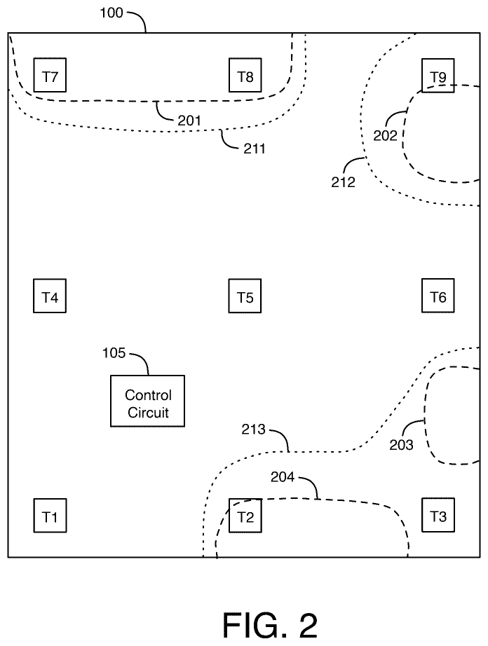

FIG. 2 is a diagram that illustrates an example of a temperature map showing hot spots in configurable integrated circuit (IC) 100 that occur as a result of a workload of a circuit design for the IC 100 generating heat. A temperature map generator circuit (e.g., in computer system 101 shown in FIG. 1) generates a temperature map for the IC 100 configured with a circuit design, such as the temperature map shown in FIG. 2. The temperature map for the IC 100 indicates the temperatures across the entire area of the IC 100. The temperature map generator circuit can generate the temperature map information about the circuit design for the IC including the identity and location of one or more circuit blocks in IC 100 generating hot spots.

In the example of FIG. 2, IC die 100 includes 9 temperature sensors T1, T2, T3, T4, T5, T6, T7, T8, and T9. Nine temperature sensors T1-T9 are shown in FIG. 2 merely as an example. An IC using the techniques disclosed herein can have any number of temperature sensors.

The temperature map indicates any hot spots in IC 100. The temperature map shown in FIG. 2 indicates 4 hot spots 201, 202, 203, and 204 in IC 100 that are delineated by a first type of dotted lines. As an example, the hot spots 201-204 shown in FIG. 2 may be generated by a workload for a circuit design for IC 100 that functions as a high speed network accelerator. According to this example, hot spots 201-204 occur at the locations of input/output (IO) circuit blocks in IC 100 that exchange data with external memory (e.g., dynamic random access memory (DRAM)). In the example of FIG. 2, temperature sensors T7-T8 are in hot spot 201, temperature sensor T2 overlaps with hot spot 204, and temperature sensor T9 overlaps with hot spot 202.

The temperature map generator circuit can generate a temperature map for a circuit design for IC 100 that shows fine variations in the temperatures across the circuit design using, as examples, a gray shaded map or a color coded map. FIG. 2, as an example, shows a temperature map for a circuit design for IC 100 that indicates temperatures in the circuit design that are above a first threshold (e.g., hots spots 201-204) as delineated by the first type of dotted lines and temperatures in the circuit design that are above a second threshold that is less than the first threshold (e.g., regions 211, 212, and 213) as delineated by a second type of dotted lines. The hot spots in IC 100 (e.g., hot spot 203) can be identified in locations in IC 100 that are different than the locations of the temperature sensors T1-T9 in IC 100.

The synthesis tool 102 shown in FIG. 1 also generates power versus temperature thermal coefficients for the circuit blocks that are generating the one or more hot spots in the circuit design for the configurable IC based on power information that indicates the power generated by each circuit block in the configurable IC for different performance scenarios and based on the influence coefficient matrices (ICM). The power versus temperature thermal coefficients for each of the circuit blocks in the circuit design can be used to generate power versus temperature curves for each circuit block. Each of these power versus temperature curves indicates the temperatures of one or more circuit blocks at different power and/or performance levels. In the example of FIG. 2, the hot spot 203 does not have a temperature sensor. Instead of using a temperature sensor to monitor hot spot 203, the temperature of hot spot 203 is determined by extrapolating the temperature using the power versus temperature thermal coefficients for the circuit blocks generating hot spot 203 and/or the power versus temperature curves for these circuit blocks.

The information indicating the circuit blocks (i.e., the hottest circuit blocks) that are causing the one or more hot spots in the circuit design for the configurable IC, the thermal coefficients used to map power versus temperature for these circuit blocks in the circuit design, and/or the temperature map for the circuit design are provided to the configurable IC 100 as part of the configuration bitstream 103 and stored within a secure enclave of IC 100 in control circuit 105 to prevent tampering, as shown in FIG. 1.

The temperature map generator circuit in computer system 101 provides the temperature map and/or the locations of any hot spots indicated in the temperature map in the configuration bitstream 103 to thermal management software in the thermal management controller 106. The temperature map generator circuit can also provide information indicating the impact of power reduction to temperature for any circuit blocks in the circuit design for IC 100 that are in, and/or are contributing to, one or more hot spots indicated in the temperature map as the power versus temperature thermal coefficients in the configuration bitstream 103 to the thermal management software in the thermal management controller 106.

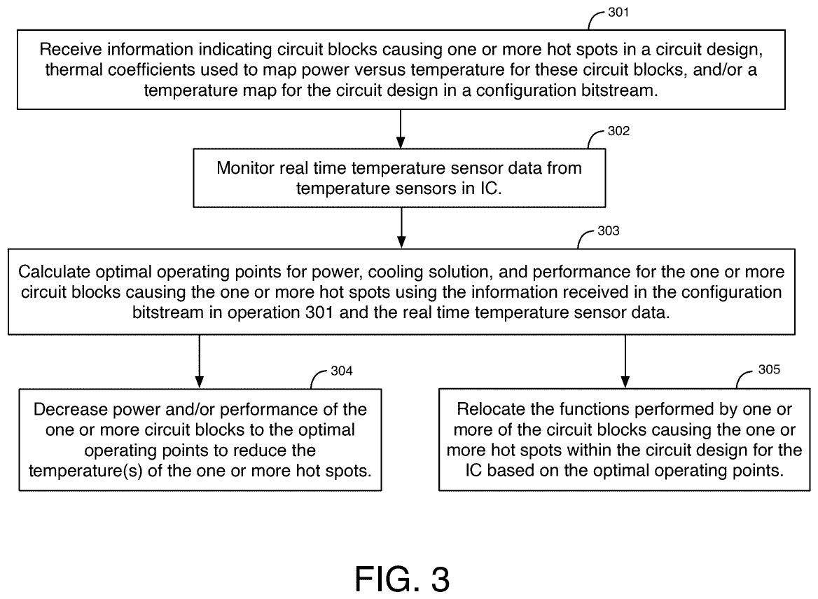

FIG. 3 is a flow chart that illustrates examples of operations that can be performed to reduce the temperature of one or more hot spots in a circuit design for a configurable integrated circuit (IC). In operation 301, the configurable IC 100 receives information indicating the circuit blocks causing the one or more hot spots in the circuit design for the configurable IC, thermal coefficients used to map power versus temperature for these circuit blocks in the circuit design, and/or the temperature map for the circuit design in configuration bitstream 103.

Referring to FIG. 1, configurable IC 100 includes temperature sensors 104 that are spread across the area of the IC die 100. Temperature sensors T1-T9 shown in FIG. 2 are examples of temperature sensors 104. Each of the temperature sensors 104 and T1-T9 senses the temperature of the IC die 100 at a specific location in the IC die 100. Each of the temperature sensors 104 and T1-T9 sends real time temperature sensor data to the control circuit 105 that indicates the temperature at the specific location in the IC die 100 in real time. The power versus temperature thermal coefficients enable the thermal management controller 106 to dynamically calculate a junction temperature for any location in IC die 100 using the real time temperature sensor data from the temperature sensors 104 in IC die 100.

Referring to FIG. 3, the thermal management controller 106 monitors the real time temperature sensor data from the temperature sensors 104 continuously in operation 302. The thermal management controller circuit 106 can identify at least one hot spot in at least one location in the IC 100 that is different from locations of the temperature sensors in the IC 100 using the temperature sensor data from the temperature sensors 104 and the thermal coefficients.

The thermal management controller 106 also calculates the ramp rate of the temperatures from each of the temperature sensors 104 in real time. If the temperature measured by any of the temperature sensors 104 increases above a predefined threshold, and if the ramp rate of the temperature from that temperature sensor 104 is high enough to indicate that the temperature measured by the temperature sensor (and hence the IC die temperature) will increase above the temperature limit of the IC die 100, the thermal management controller 106 initiates a power management algorithm in power management controller 107 that adjusts the power generated by one or more circuit blocks in the circuit design for IC 100 that are causing the high temperature using the power versus temperature thermal coefficients.

The thermal management controller 106 uses the power versus temperature thermal coefficients for the circuit blocks causing the hot spots in the circuit design to generate power versus temperature curves. Based on the information indicating the circuit blocks that are generating the one or more hot spots in the circuit design for the configurable IC and the relationship between the power generated by these circuit blocks and IC die temperature (i.e., as indicated by the power versus temperature curves), the power management controller 107 identifies the power management state of these circuit blocks best suited to yield the optimal balance of junction temperature, thermal solution (e.g., fan speed), and performance of the IC die 100.

In operation 303, the thermal management software in thermal management controller 106 calculates the optimal operating points for power, cooling solution, and performance for the one or more circuit blocks causing the one or more hot spots (e.g., one or more of hot spots 201-204) using the information received from computer system 101 in configuration bitstream 103 in operation 301 described above and using the real time temperature sensor data monitored in operation 302 and described above. The thermal management software in thermal management controller 106 then provides the optimal operating points for power and performance for the one or more circuit blocks causing the hot spot(s) to power management controller circuit 107. In operation 304, the power management controller circuit 107 uses the optimal operating points for the power and performance for the one or more circuit blocks causing the one or more hot spots to decrease the power and/or performance of these one or more circuit blocks to the optimal operating points to reduce the temperature(s) of the one or more hot spots using the power management algorithm.

As an example that is not intended to be limiting, the thermal management software may calculate that the optimal operating points for power, cooling solution, and performance can be achieved by reducing the bandwidth of data transmission through IO blocks in IC 100 generating hot spots (e.g., from 1600 mega transfers per second (MTS) to 800 MTS) based on the incoming data transmission bandwidth, IC die temperature, and the fan speed. If the data transmission bandwidth through the IO blocks is reduced, the bandwidths of the configurable logic circuits in the fabric region of IC 100 that receive the data and the external data transmission bandwidth also need to be reduced to prevent data packets from being dropped. The thermal management software can send a request to the power management controller 107 to reduce the clock signal (e.g., from 1600 megahertz (MHz) to 800 MHz) for the external data transmission and to reduce the core fabric clock signal that clocks the configurable logic circuits that receive the data (e.g., from 312.5 MHz to 156.25 MHz). This solution can allow for an application to meet immediate performance requirements of the workload for transmitting the data, while minimizing the amount of power required to cool the IC 100 to an acceptable junction temperature.

In addition to, or instead of, decreasing the power and/or performance of the circuit blocks causing the hot spots, the thermal management software in thermal management controller 106 can use the optimal operating points for power, cooling solution, and performance for the one or more circuit blocks causing the one or more hot spots to relocate functions performed by one or more of these circuit blocks within the circuit design for the IC to reduce the temperature(s) of one or more of these hot spots in operation 305. For example, the thermal management software can change the placement of the functions performed by one or more of the circuit blocks causing one or more of the hots spots 201-204 shown in FIG. 2 using partial reconfiguration of configurable IC 100 to reduce the temperatures of one or more of these hot spots. If, for example, one or more of the circuit blocks causing one or more of the hot spots are IO circuit blocks, the thermal management software can relocate the functions performed by one or more of the IO circuit blocks causing one or more of the hot spots to previously unused IO circuit blocks in the IC 100. As another example, if one or more of the circuit blocks causing one or more of the hot spots are configurable logic circuits blocks in the fabric region of IC 100, the thermal management software can relocate the functions performed by these configurable logic circuit blocks in the circuit design for the IC to configurable logic circuit blocks in the IC 100 that were previously unused by the circuit design using partial reconfiguration.

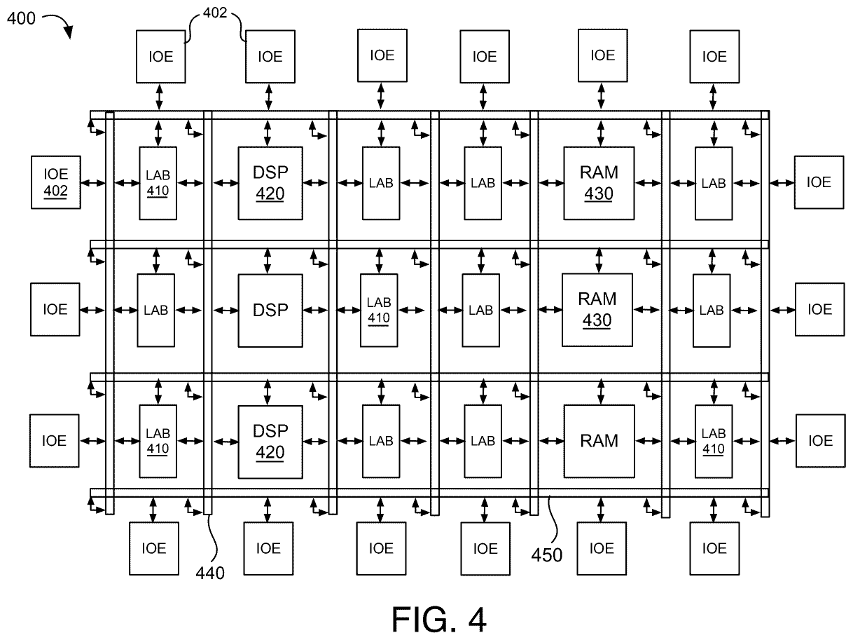

FIG. 4 is a diagram of an illustrative example of a configurable integrated circuit (IC) 400. Configurable IC 400 is an example of an IC that can include the examples disclosed herein with respect to FIGS. 1-3. As shown in FIG. 4, the configurable integrated circuit 400 includes a two-dimensional array of configurable logic circuit blocks in a fabric region, including logic array blocks (LABs) 410 and other configurable logic circuit blocks, such as random access memory (RAM) blocks 430 and digital signal processing (DSP) blocks 420, for example. Configurable logic circuit blocks, such as LABs 410, can include smaller configurable regions (e.g., configurable logic elements, configurable logic blocks, or adaptive logic modules (ALMs)) that receive input signals and perform custom functions on the input signals to produce output signals.

The configurable integrated circuit 400 also includes programmable interconnect circuitry in the form of vertical routing channels 440 (i.e., interconnects formed along a vertical axis of configurable integrated circuit 400) and horizontal routing channels 450 (i.e., interconnects formed along a horizontal axis of configurable integrated circuit 400), each routing channel including at least one track to route at least one wire. One or more of the routing channels 440 and/or 450 can be part of a network-on-chip (NOC) having router circuits.

In addition, the configurable integrated circuit 400 has input/output elements (IOEs) 402 (e.g., including IO circuit blocks) for driving signals off of configurable integrated circuit 400 and for receiving signals from other devices. Input/output elements 402 can include parallel input/output circuitry, serial data transceiver circuitry, differential receiver and transmitter circuitry, or other circuitry used to connect one integrated circuit to another integrated circuit. Input/output elements 402 can include general purpose input/output (GPIO) circuitry (e.g., on the top and bottoms edges of IC 400), high-speed input/output (HSIO) circuitry (e.g., on the left edge of IC 400), and on-package input/output (OPIOs) circuitry (e.g., on the right edge of IC 400).

As shown, input/output elements 402 can be located around the periphery of the IC. If desired, the configurable integrated circuit 400 can have input/output elements 402 arranged in different ways. For example, input/output elements 402 can form one or more columns of input/output elements that can be located anywhere on the configurable integrated circuit 400 (e.g., distributed evenly across the width of the configurable integrated circuit). If desired, input/output elements 402 can form one or more rows of input/output elements (e.g., distributed across the height of the configurable integrated circuit). Alternatively, input/output elements 402 can form islands of input/output elements that can be distributed over the surface of the configurable integrated circuit 400 or clustered in selected areas.

Note that other routing topologies, besides the topology of the interconnect circuitry depicted in FIG. 4, can be used. For example, the routing topology can include wires that travel diagonally or that travel horizontally and vertically along different parts of their extent as well as wires that are perpendicular to the device plane in the case of three dimensional integrated circuits, and the driver of a wire can be located at a different point than one end of a wire. The routing topology can include global wires that span substantially all of configurable integrated circuit 400, fractional global wires such as wires that span part of configurable integrated circuit 400, staggered wires of a particular length, smaller local wires, or any other suitable interconnection resource arrangement.

Furthermore, it should be understood that examples disclosed herein may be implemented in any type of integrated circuit. If desired, the functional blocks of such an integrated circuit can be arranged in more levels or layers in which multiple functional blocks are interconnected to form still larger blocks. Other device arrangements can use functional blocks that are not arranged in rows and columns.

Configurable integrated circuit 400 can also contain programmable memory elements. The memory elements can be loaded with configuration data (also called programming data) using input/output elements (IOEs) 402. Once loaded, the memory elements each provide a corresponding static control signal that controls the operation of an associated functional block (e.g., LABs 410, DSP 420, RAM 430, or input/output elements 402).

In a typical scenario, the outputs of the loaded memory elements are applied to the gates of field-effect transistors in a functional block to turn certain transistors on or off and thereby configure the logic in the functional block including the routing paths. Programmable logic circuit elements that are controlled in this way include parts of multiplexers (e.g., multiplexers used for forming routing paths in interconnect circuits), look-up tables, logic arrays, AND, OR, NAND, and NOR logic gates, pass gates, etc.

The memory elements can use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory or programmable memory elements.

The programmable memory elements can be organized in a configuration memory array consisting of rows and columns. A data register that spans across all columns and an address register that spans across all rows can receive configuration data. The configuration data can be shifted onto the data register. When the appropriate address register is asserted, the data register writes the configuration data to the configuration memory elements of the row that was designated by the address register.

Configurable integrated circuit 400 can include configuration memory that is organized in sectors, whereby a sector can include the configuration bits that specify the function and/or interconnections of the subcomponents and wires in or crossing that sector. Each sector can include separate data and address registers.

The configurable IC 400 of FIG. 4 is merely one example of an IC that can be used with embodiments disclosed herein. The embodiments disclosed herein can be used with any suitable electronic integrated circuit or system. For example, the embodiments disclosed herein can be used with numerous types of electronic devices such as processor integrated circuits, central processing units, memory integrated circuits, graphics processing unit integrated circuits, application specific standard products (ASSPs), application specific integrated circuits (ASICs), and configurable logic integrated circuits. Examples of configurable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein can be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

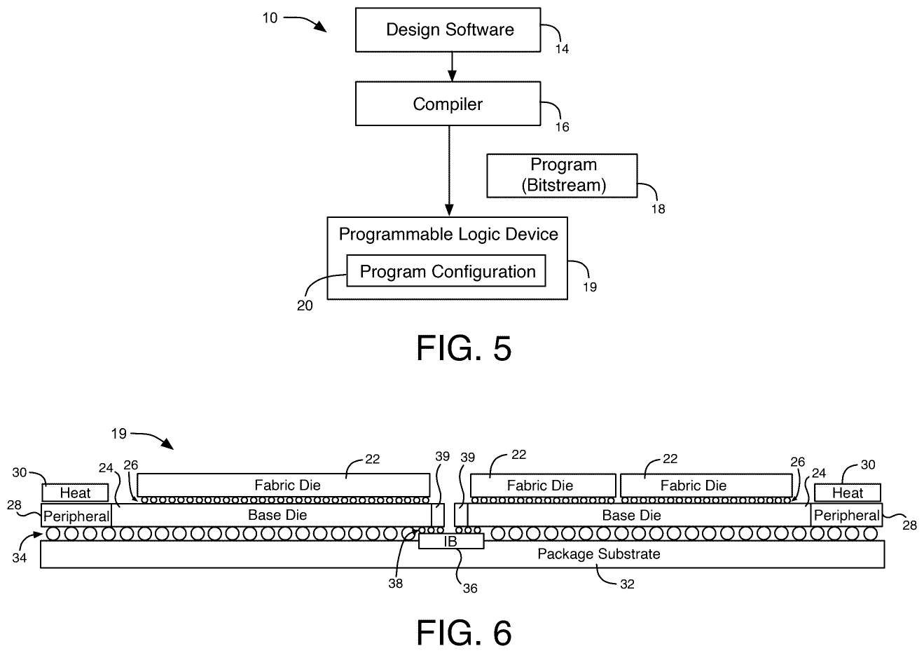

FIG. 5 illustrates a block diagram of a system 10 that can be used to implement a circuit design to be programmed onto a programmable logic device 19 using design software. A designer can implement circuit design functionality on an integrated circuit, such as a reconfigurable programmable logic device 19 (e.g., a field programmable gate array (FPGA)). The designer can implement the circuit design to be programmed onto the programmable logic device 19 using design software 14. The design software 14 can use a compiler 16 to generate a low-level circuit-design program (bitstream) 18, sometimes known as a program object file and/or configuration program, that programs the programmable logic device 19. Thus, the compiler 16 can provide machine-readable instructions representative of the circuit design to the programmable logic device 19. For example, the programmable logic device 19 can receive one or more programs (bitstreams) 18 that describe the hardware implementations that should be stored in the programmable logic device 19. A program (bitstream) 18 can be programmed into the programmable logic device 19 as a configuration program 20. The configuration program 20 can, in some cases, represent an accelerator function to perform for machine learning, video processing, voice recognition, image recognition, or other highly specialized task.

In some implementations, a programmable logic device can be any integrated circuit device that includes a programmable logic device with two separate integrated circuit die where at least some of the programmable logic fabric is separated from at least some of the fabric support circuitry that operates the programmable logic fabric. One example of such a programmable logic device is shown in FIG. 6, but many others can be used, and it should be understood that this disclosure is intended to encompass any suitable programmable logic device where programmable logic fabric and fabric support circuitry are at least partially separated on different integrated circuit die.

FIG. 6 is a diagram that depicts an example of the programmable logic device 19 that includes three fabric die 22 and two base die 24 that are connected to one another via microbumps 26. In the example of FIG. 6, at least some of the programmable logic fabric of the programmable logic device 19 is in the three fabric die 22, and at least some of the fabric support circuitry that operates the programmable logic fabric is in the two base die 24. For example, some of the circuitry of configurable IC 400 shown in FIG. 4 (e.g., LABs 410, DSP 420, and RAM 430) can be located in the fabric die 22 and some of the circuitry of IC 400 (e.g., input/output elements 402) can be located in the base die 24.

Although the fabric die 22 and base die 24 appear in a one-to-one relationship or a two-to-one relationship in FIG. 6, other relationships can be used. For example, a single base die 24 can attach to several fabric die 22, or several base die 24 can attach to a single fabric die 22, or several base die 24 can attach to several fabric die 22 (e.g., in an interleaved pattern). Peripheral circuitry 28 can be attached to, embedded within, and/or disposed on top of the base die 24, and heat spreaders 30 can be used to reduce an accumulation of heat on the programmable logic device 19. The heat spreaders 30 can appear above, as pictured, and/or below the package (e.g., as a double-sided heat sink). The base die 24 can attach to a package substrate 32 via conductive bumps 34. In the example of FIG. 6, two pairs of fabric die 22 and base die 24 are shown communicatively connected to one another via an interconnect bridge 36 (e.g., an embedded multi-die interconnect bridge (EMIB)) and microbumps 38 at bridge interfaces 39 in base die 24.

In combination, the fabric die 22 and the base die 24 can operate in combination as a programmable logic device 19 such as a field programmable gate array (FPGA). It should be understood that an FPGA can, for example, represent the type of circuitry, and/or a logical arrangement, of a programmable logic device when both the fabric die 22 and the base die 24 operate in combination. Moreover, an FPGA is discussed herein for the purposes of this example, though it should be understood that any suitable type of programmable logic device can be used.

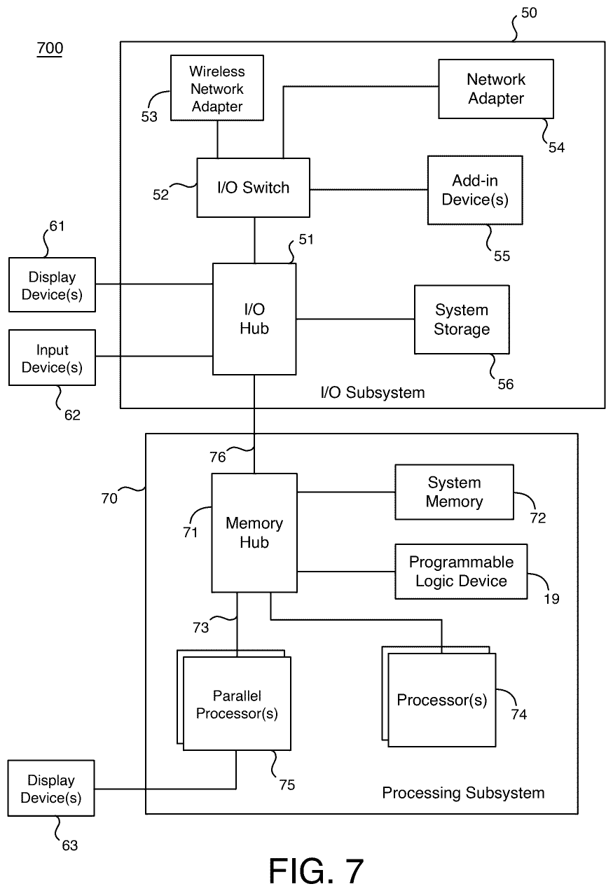

FIG. 7 is a block diagram illustrating a computing system 700 configured to implement one or more aspects of the embodiments described herein. The computing system 700 includes a processing subsystem 70 having one or more processor(s) 74, a system memory 72, and a programmable logic device 19 communicating via an interconnection path that can include a memory hub 71. The memory hub 71 can be a separate component within a chipset component or can be integrated within the one or more processor(s) 74. The memory hub 71 couples with an input/output (I/O) subsystem 50 via a communication link 76. The I/O subsystem 50 includes an input/output (I/O) hub 51 that can enable the computing system 700 to receive input from one or more input device(s) 62. Additionally, the I/O hub 51 can enable a display controller, which can be included in the one or more processor(s) 74, to provide outputs to one or more display device(s) 61. In one embodiment, the one or more display device(s) 61 coupled with the I/O hub 51 can include a local, internal, or embedded display device.

In one embodiment, the processing subsystem 70 includes one or more parallel processor(s) 75 coupled to memory hub 71 via a bus or other communication link 73. The communication link 73 can use one of any number of standards based communication link technologies or protocols, such as, but not limited to, PCI Express, or can be a vendor specific communications interface or communications fabric. In one embodiment, the one or more parallel processor(s) 75 form a computationally focused parallel or vector processing system that can include a large number of processing cores and/or processing clusters, such as a many integrated core (MIC) processor. In one embodiment, the one or more parallel processor(s) 75 form a graphics processing subsystem that can output pixels to one of the one or more display device(s) 61 coupled via the I/O Hub 51. The one or more parallel processor(s) 75 can also include a display controller and display interface (not shown) to enable a direct connection to one or more display device(s) 63.

Within the I/O subsystem 50, a system storage unit 56 can connect to the I/O hub 51 to provide a storage mechanism for the computing system 700. An I/O switch 52 can be used to provide an interface mechanism to enable connections between the I/O hub 51 and other components, such as a network adapter 54 and/or a wireless network adapter 53 that can be integrated into the platform, and various other devices that can be added via one or more add-in device(s) 55. The network adapter 54 can be an Ethernet adapter or another wired network adapter. The wireless network adapter 53 can include one or more of a Wi-Fi, Bluetooth, near field communication (NFC), or other network device that includes one or more wireless radios.

The computing system 700 can include other components not shown in FIG. 7, including other port connections, optical storage drives, video capture devices, and the like, that can also be connected to the I/O hub 51. Communication paths interconnecting the various components in FIG. 7 can be implemented using any suitable protocols, such as PCI (Peripheral Component Interconnect) based protocols (e.g., PCI-Express), or any other bus or point-to-point communication interfaces and/or protocol(s), such as the NV-Link high-speed interconnect, or interconnect protocols known in the art.

In one embodiment, the one or more parallel processor(s) 75 incorporate circuitry optimized for graphics and video processing, including, for example, video output circuitry, and constitutes a graphics processing unit (GPU). In another embodiment, the one or more parallel processor(s) 75 incorporate circuitry optimized for general purpose processing, while preserving the underlying computational architecture. In yet another embodiment, components of the computing system 700 can be integrated with one or more other system elements on a single integrated circuit. For example, the one or more parallel processor(s) 75, memory hub 71, processor(s) 74, and I/O hub 51 can be integrated into a system on chip (SoC) integrated circuit. Alternatively, the components of the computing system 700 can be integrated into a single package to form a system in package (SIP) configuration. In one embodiment, at least a portion of the components of the computing system 700 can be integrated into a multi-chip module (MCM), which can be interconnected with other multi-chip modules into a modular computing system.

The computing system 700 shown herein is illustrative. Other variations and modifications are also possible. The connection topology, including the number and arrangement of bridges, the number of processor(s) 74, and the number of parallel processor(s) 75, can be modified as desired. For instance, in some embodiments, system memory 72 is connected to the processor(s) 74 directly rather than through a bridge, while other devices communicate with system memory 72 via the memory hub 71 and the processor(s) 74. In other alternative topologies, the parallel processor(s) 75 are connected to the I/O hub 51 or directly to one of the one or more processor(s) 74, rather than to the memory hub 71. In other embodiments, the I/O hub 51 and memory hub 71 can be integrated into a single chip. Some embodiments can include two or more sets of processor(s) 74 attached via multiple sockets, which can couple with two or more instances of the parallel processor(s) 75.

Some of the particular components shown herein are optional and may not be included in all implementations of the computing system 700. For example, any number of add-in cards or peripherals can be supported, or some components can be eliminated. Furthermore, some architectures can use different terminology for components similar to those illustrated in FIG. 7. For example, the memory hub 71 can be referred to as a Northbridge in some architectures, while the I/O hub 51 can be referred to as a Southbridge.

Additional examples are now described. Example 1 is an integrated circuit comprising: temperature sensors that generate temperature sensor data indicating temperatures in the integrated circuit; a thermal management controller circuit that identifies at least one hot spot in at least one location that is different from locations of the temperature sensors using the temperature sensor data and thermal coefficient data; and a power management controller circuit that decreases power of at least one circuit block corresponding to the at least one hot spot in a circuit design for the integrated circuit to reduce a temperature of the at least one hot spot.

In Example 2, the integrated circuit of Example 1, wherein the thermal coefficient data for the integrated circuit is calculated during synthesis of the circuit design and is used to determine the temperatures across the integrated circuit based on the circuit design.

In Example 3, the integrated circuit of any one of Examples 1-2, wherein the thermal management controller circuit generates power versus temperature curves for the at least one circuit block without using the temperature sensor data from the temperature sensors.

In Example 4, the integrated circuit of any one of Examples 1-3, wherein the thermal coefficients data is calculated during synthesis of the circuit design and is embedded in a configuration bitstream file used to configure the integrated circuit to implement the circuit design.

In Example 5, the integrated circuit of any one of Examples 1-4, wherein the thermal management controller circuit calculates a ramp rate of one of the temperatures generated by one of the temperature sensors, and wherein the power management controller circuit adjusts the power generated by the at least one circuit block in the circuit design if the one of the temperatures increases above a predefined threshold and if the ramp rate of the one of the temperatures indicates that the one of the temperatures is on a path to increase above a temperature limit of the integrated circuit.

In Example 6, the integrated circuit of any one of Examples 1-5, wherein the thermal management controller circuit changes a placement of functions performed by the at least one circuit block in the integrated circuit using partial reconfiguration of the integrated circuit to reduce the temperature of the at least one hot spot.

In Example 7, the integrated circuit of any one of Examples 1-6, wherein thermal management controller circuit determines operating points for a cooling solution for the at least one circuit block using the temperature sensor data, information identifying the at least one circuit block corresponding to the at least one hot spot, and the thermal coefficient data, and wherein the thermal management controller circuit adjusts the cooling solution based on the operating points.

In Example 8, the integrated circuit of any one of Examples 1-7, wherein the thermal management controller circuit determines the operating points for the power and a performance of the at least one circuit block corresponding to the at least one hot spot additionally using a maximum junction temperature of the integrated circuit.

Example 9 is a method for thermal management in an integrated circuit, the method comprising: receiving temperature sensor data from temperature sensors in the integrated circuit; identifying one or more hot spots in at least one location in the integrated circuit that is different from locations of the temperature sensors in the integrated circuit using the temperature sensor data and thermal coefficients; and changing a power, a performance, or a location of one or more circuit blocks corresponding to the one or more hot spots in a circuit design for the integrated circuit to reduce a temperature of the one or more hot spots using at least one of a power management controller circuit or the thermal management controller circuit.

In Example 10, the method of Example 9, wherein changing the power, the performance, or the location of the one or more circuit blocks further comprises: changing a placement of functions performed by the one or more circuit blocks in the circuit design to one or more unused circuits in the integrated circuit.

In Example 11, the method of any one of Examples 9-10, wherein changing the power, the performance, or the location of the one or more circuit blocks further comprises: decreasing the power of the one or more circuit blocks based on operating points for the power of the one or more circuit blocks.

In Example 12, the method of any one of Examples 9-11, wherein changing the power, the performance, or the location of the one or more circuit blocks further comprises: decreasing the performance of the one or more circuit blocks based on operating points for the performance of the one or more circuit blocks.

In Example 13, the method of any one of Examples 9-12 further comprises: receiving the thermal coefficients that are calculated during synthesis of the circuit design and that are embedded in a configuration bitstream file used to configure the integrated circuit to implement the circuit design; and calculating the temperature of the one or more hot spots using the thermal coefficients.

In Example 14, the method of any one of Examples 9-13 further comprises: generating power versus temperature curves for each of the one or more hot spots using the thermal coefficients used to map the power versus the temperature for the one or more circuit blocks.

In Example 15, the method of any one of Examples 9-14 further comprises: using the thermal coefficients for the integrated circuit that are calculated during synthesis of the circuit design to determine temperatures across the integrated circuit based on the circuit design.

Example 16 is a non-transitory computer readable storage medium comprising computer readable instructions stored thereon for causing an integrated circuit to: receive temperature data from temperature sensors in the integrated circuit; identify a hot spot at a location in the integrated circuit that is different from locations of the temperature sensors in the integrated circuit using the temperature data and thermal coefficients with a thermal management controller circuit; and adjust a power, a performance, or a location of at least one circuit within a circuit design for the integrated circuit that causes the hot spot in the circuit design based on the power or the performance to reduce a temperature of the hot spot.

In Example 17, the non-transitory computer readable storage medium of Example 16, wherein the computer readable instructions further cause the integrated circuit to: change a placement of functions performed by the at least one circuit in the circuit design using partial reconfiguration of the integrated circuit to reduce the temperature of the hot spot.

In Example 18, the non-transitory computer readable storage medium of any one of Examples 16-17, wherein the computer readable instructions further cause the integrated circuit to: determine the power and the performance of the at least one circuit that reduces the temperature of the hot spot using a temperature map that indicates temperatures across the circuit design.

In Example 19, the non-transitory computer readable storage medium of any one of Examples 16-18, wherein the computer readable instructions further cause the integrated circuit to: use the thermal coefficients for the integrated circuit that are calculated during synthesis of the circuit design to determine temperatures across the integrated circuit based on the circuit design.

In Example 20, the non-transitory computer readable storage medium of any one of Examples 16-19, wherein the computer readable instructions further cause the integrated circuit to: receive the thermal coefficients that are calculated during synthesis of the circuit design and that are embedded in a configuration bitstream file for configuring the integrated circuit to implement the circuit design; and calculate the temperature of the hot spot using the thermal coefficients.

The foregoing description of the exemplary embodiments has been presented for the purpose of illustration. The foregoing description is not intended to be exhaustive or to be limiting to the examples disclosed herein. The foregoing is merely illustrative of the principles of this disclosure and various modifications can be made by those skilled in the art. The foregoing embodiments may be implemented individually or in any combination.

What is claimed is:

1. An integrated circuit comprising:
temperature sensors that generate temperature sensor data indicating temperatures in the integrated circuit;
a thermal management controller circuit that identifies at least one hot spot in at least one location that is different from locations of the temperature sensors using the temperature sensor data and thermal coefficient data; and
a power management controller circuit that decreases power of at least one circuit block corresponding to the at least one hot spot in a circuit design for the integrated circuit to reduce a temperature of the at least one hot spot.

2. The integrated circuit of claim 1, wherein the thermal coefficient data is calculated during synthesis of the circuit design and is used to determine the temperatures across the integrated circuit based on the circuit design.

3. The integrated circuit of claim 1, wherein the thermal management controller circuit generates power versus temperature curves for the at least one circuit block.

4. The integrated circuit of claim 1, wherein the thermal coefficient data is calculated during synthesis of the circuit design and is embedded in a configuration bitstream file used to configure the integrated circuit to implement the circuit design.

5. The integrated circuit of claim 1, wherein the thermal management controller circuit calculates a ramp rate of one of the temperatures generated by one of the temperature sensors, and wherein the power management controller circuit adjusts the power generated by the at least one circuit block in the circuit design if the one of the temperatures increases above a predefined threshold and if the ramp rate of the one of the temperatures indicates that the one of the temperatures is on a path to increase above a temperature limit of the integrated circuit.

6. The integrated circuit of claim 1, wherein the thermal management controller circuit changes a placement of functions performed by the at least one circuit block in the integrated circuit using partial reconfiguration of the integrated circuit to reduce the temperature of the at least one hot spot.

7. The integrated circuit of claim 1, wherein thermal management controller circuit determines operating points for a cooling solution for the at least one circuit block using the temperature sensor data, information identifying the at least one circuit block corresponding to the at least one hot spot, and the thermal coefficient data, and wherein the thermal management controller circuit adjusts the cooling solution based on the operating points.

8. The integrated circuit of claim 1, wherein the thermal management controller circuit determines operating points for the power and a performance of the at least one circuit block corresponding to the at least one hot spot using a maximum junction temperature of the integrated circuit.

9. A method for thermal management in an integrated circuit, the method comprising:
receiving temperature sensor data from temperature sensors in the integrated circuit;
identifying one or more hot spots in at least one location in the integrated circuit that is different from locations of the temperature sensors in the integrated circuit using the temperature sensor data and thermal coefficients with a thermal management controller circuit; and
changing a power, a performance, or a location of one or more circuit blocks corresponding to the one or more hot spots in a circuit design for the integrated circuit to reduce a temperature of the one or more hot spots using at least one of a power management controller circuit or the thermal management controller circuit.

10. The method of claim 9, wherein changing the power, the performance, or the location of the one or more circuit blocks further comprises:
changing a placement of functions performed by the one or more circuit blocks in the circuit design to one or more unused circuits in the integrated circuit.

11. The method of claim 9, wherein changing the power, the performance, or the location of the one or more circuit blocks further comprises:
decreasing the power of the one or more circuit blocks based on operating points for the power of the one or more circuit blocks.

12. The method of claim 9, wherein changing the power, the performance, or the location of the one or more circuit blocks further comprises:
decreasing the performance of the one or more circuit blocks based on operating points for the performance of the one or more circuit blocks.

13. The method of claim 9 further comprising:
receiving the thermal coefficients that are calculated during synthesis of the circuit design and that are embedded in a configuration bitstream used to configure the integrated circuit to implement the circuit design; and
calculating the temperature of the one or more hot spots using the thermal coefficients.

14. The method of claim 9 further comprising:
generating power versus temperature curves for each of the one or more hot spots using the thermal coefficients used to map the power versus the temperature for the one or more circuit blocks.

15. The method of claim 9 further comprising:
using the thermal coefficients for the integrated circuit that are calculated during synthesis of the circuit design to determine temperatures across the integrated circuit based on the circuit design.

16. A non-transitory computer readable storage medium comprising computer readable instructions stored thereon for causing an integrated circuit to:
receive temperature data from temperature sensors in the integrated circuit;
identify a hot spot at a location in the integrated circuit that is different from locations of the temperature sensors in the integrated circuit using the temperature data and thermal coefficients with a thermal management controller circuit; and
adjust a power, a performance, or a location of at least one circuit within a circuit design for the integrated circuit that causes the hot spot in the circuit design based on the power or the performance to reduce a temperature of the hot spot.

17. The non-transitory computer readable storage medium of claim 16, wherein the computer readable instructions further cause the integrated circuit to:
change a placement of functions performed by the at least one circuit in the circuit design using partial reconfiguration of the integrated circuit to reduce the temperature of the hot spot.

18. The non-transitory computer readable storage medium of claim 16, wherein the computer readable instructions further cause the integrated circuit to:
determine the power and the performance of the at least one circuit that reduces the temperature of the hot spot using a temperature map that indicates temperatures across the circuit design.

19. The non-transitory computer readable storage medium of claim 16, wherein the computer readable instructions further cause the integrated circuit to:
use the thermal coefficients for the integrated circuit that are calculated during synthesis of the circuit design to determine temperatures across the integrated circuit based on the circuit design.

20. The non-transitory computer readable storage medium of claim 16, wherein the computer readable instructions further cause the integrated circuit to:
receive the thermal coefficients that are calculated during synthesis of the circuit design and that are embedded in a configuration bitstream for configuring the integrated circuit to implement the circuit design; and
calculate the temperature of the hot spot using the thermal coefficients.
